(19) United States
(12) Patent Application Publication
(10) Pub. No.: US 2011/0161637 A1
(43) Pub. Date: Jun. 30, 2011

(54) APPARATUS AND METHOD FOR PARALLEL PROCESSING

(75) Inventors: Kue-Hwan SIHN, Hwaseong-si (KR); Hee-Jin Chung, Seoul (KR); Dong-Gun Kim, Suwon-si (KR)

(73) Assignee: SAMSUNG ELECTRONICS CO., LTD., Suwon-si (KR)

(21) Appl. No.: 12/845,923

(22) Filed: Jul. 29, 2010

(30) Foreign Application Priority Data
Dec. 28, 2009 (KR) 10-2009-0131713

(51) Int. Cl. G06F 9/38; G06F 9/46

(52) U.S. Cl. 712/220; 718/104; 712/E09.049

(57) ABSTRACT

An apparatus and method for parallel processing in consideration of degree of parallelism are provided. One of a task parallelism and a data parallelism is dynamically selected while a job is processed. In response to a task parallelism being selected, a sequential version code is allocated to a core or processor for processing a job. In response to a data parallelism being selected, a parallel version code is allocated to a core a processor for processing a job.

### CROSS-REFERENCE TO RELATED APPLICATION(S)

This application claims the benefit under 35 U.S.C. §119(a) of Korean Patent Application No. 10-2009-0131713, filed on Dec. 28, 2009, the disclosure of which is incorporated herein by reference in its entirety for all purposes.

### BACKGROUND

1. Field

The following description relates to a parallel processing technology using a multi-processor system and a multi-core system.

2. Description of the Related Art

The system performance of a single core system has been improved in a specific way to increase operation speed, that is, by increasing clock frequency. However, the increased operation speed causes high power consumption and a substantial amount of heat production, and there are limitations to increasing operation speed in order to improve performance.

A multi-core system suggested as an alternative to the single core system includes a plurality of cores. In general, a multi-core system refers to a computing device that has at least two cores or processors. Even though the cores operate with a relatively low frequency, each core processes a predetermined job in a parallel manner while operating independent of each other, thereby improving the performance of system. In this regard, a multi processor system composed of multi-cores is widely used among computing devices. Parallel processing of some sort is common among such multi-core systems.

When a multi-core system (or multi-processor system) performs a parallel processing, the parallel processing is mainly divided into task parallelism and data parallelism. When a job is divided into tasks that are not related to each other and available to be processed in a parallel manner, such a parallel processing is referred to as a task parallelism. Task parallelism is attained when each processor executes a different process, which may be on the same or different data. In addition, when input data or computation regions of a predetermined task is dividable, portions of the task are processed by a plurality of cores and respective processing results are collected, such a parallel implementation is referred to as a data parallelism. Data parallelism is attained when each processor performs the same task on different pieces of distributed data.

Task parallelism has a low overhead, but the size of a general task is large with reference to a parallelism processing unit and different tasks have different sizes, causing severe load imbalance. In addition, for data parallelism processes, the general size of data is small with reference to a parallel processing unit and a dynamic assignment of data is possible, so load balancing is obtained, but the parallel overhead is considerable.

As described above, the task parallelism and the data parallelism each have their own strengths/weaknesses related to the parallel processing unit. However, since the size of parallel processing unit for a predetermined job is fixed in advance, it is difficult to avoid the inherent weaknesses of task parallelism and data parallelism.

### SUMMARY

In one general aspect, there is provided an apparatus for parallel processing, the apparatus including: at least one processing core configured to process a job, a granularity determination unit configured to determine a parallelism granularity of the job, and a code allocating unit configured to: select one of a sequential version code and a parallel version code, based on the determined parallelism granularity, and allocate the selected code to the processing core.

The apparatus may further include that the granularity determination unit is further configured to determine whether the parallelism granularity is at a task level or a data level.

The apparatus may further include that the code allocating unit is further configured to: in response to the determined parallelism granularity being at the task level, allocate a sequential version code of a task related to the job to the processing core, and in response to the determined parallelism granularity being at the data level, allocate a parallel version code of a task related to the job to the processing core.

The apparatus may further include that the code allocating unit is further configured to: in the allocating of the sequential version code of the task to the processing core, map a sequential version code of a single task to one of the processing cores in a one-to-one correspondence, and in the allocating of the parallel version code of the task to the processing core, map a parallel version code of a single task to different processing cores.

The apparatus may further include a memory unit configured to contain a multigrain task queue, configured to store at least one of: a plurality of tasks related to the job, a sequential version code of each task, a parallel version code of each task, and a predetermined task description table.

The apparatus may further include that the task description table is further configured to store at least one of: identification information of each task, dependency information between the tasks, and code information available for each task.

The apparatus may further include that the granularity determination unit is further configured to dynamically determine the parallelism granularity with reference to the memory unit.

In another general aspect, there is provided a method of parallel processing, the method including: determining a parallelism granularity of a job, selecting one of a sequential version code and a parallel version code based on the determined parallelism granularity, and allocating the selected code to at least one processing core for processing the job.

The method may further include that the determining of the parallelism granularity includes determining whether the parallelism granularity is at a task level or a data level.

The method may further include that the allocating of the selected code includes: in response to the determined parallelism granularity being at the task level, allocating a sequential version code of a task related to the job to the processing core, and in response to the determined parallelism granularity being at the data level, allocating a parallel version code of a task related to the job to the processing core.

The method may further include that the allocating of the selected code includes: mapping a sequential version code of a single task to one of the processing cores in a one-to-one correspondence, in the allocating of the sequential version code of the task to the processing core, and mapping a parallel version code of a single task to different processing cores, in the allocating of the parallel version code of the task to the processing core.

The method may further include storing, in a memory unit, at least one of: a plurality of tasks related to the job, a sequential version code of each task, a parallel version code of each task, and a predetermined task description table.

The method may further include that the task description table stores at least one of: identification information of each task, dependency information between the tasks, and code information available for each task.

The method may further include dynamically determining the parallelism granularity with reference to the memory unit.

In another general aspect, there is provided an apparatus for parallel processing, the apparatus including: a code allocating unit configured to: select one of a sequential version code and a parallel version code, based on a parallelism granularity, and allocate the selected code.

Other features and aspects will be apparent from the following detailed description, the drawings, and the claims.

### BRIEF DESCRIPTION OF THE DRAWINGS

FIG. 1 is a configuration of an example of a multi-core system.

FIG. 2 is a configuration of an example of a control processor.

FIG. 3 is an example of a job.

FIG. 4 is an example of tasks.

FIG. 5 is an example of a task description table.

FIG. 6 is an example of an execution sequence of tasks.

FIG. 7 is an example of operations of the parallel processing apparatus.

FIG. 8 is an example of a method of parallel processing.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, descriptions of well-known functions and constructions may be omitted for increased clarity and conciseness.

Hereinafter, detailed examples will be described with reference to accompanying drawings.

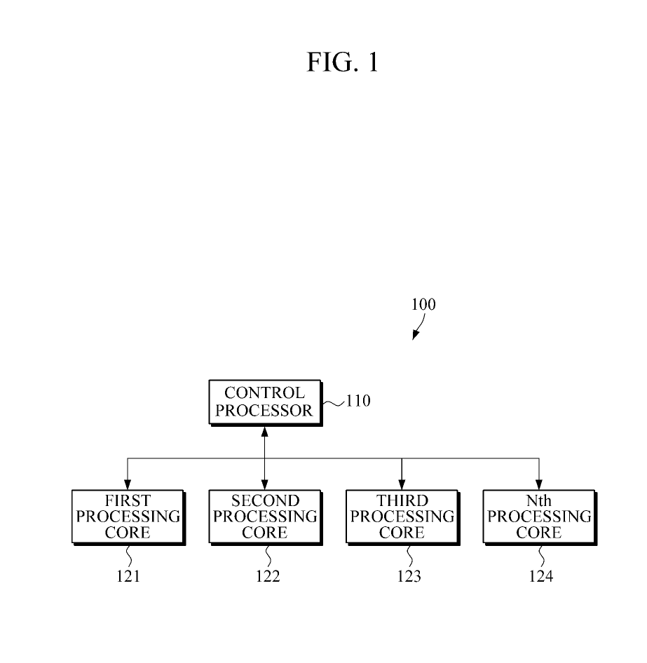

FIG. 1 shows a configuration of an example of a multi-core system.

As shown in FIG. 1, a multi-core system 100 may include a control processor 110 and a plurality of processing cores, e.g., processing cores 121, 122, 123, and 124.

Each of the processing cores 121, 122, 123, and 124 may be implemented in various forms of a processor, such as a central processing unit (CPU), a digital processing processor (DSP), and a graphic processing unit (GPU). The processing cores 121, 122, 123, and 124 may each be implemented using the same processor or different kinds of processors. In addition, one of the processing cores, in this example, the processing core 121, may be used as the control processor 110 without forming an additional control processor 110.

The processing cores 121, 122, 123, and 124 may perform parallel processing on a predetermined job according to a control instruction of the control processor 110. For the parallel processing, a predetermined job may be divided into a plurality of sub-jobs and each sub-job may be divided into a plurality of tasks. In addition, each task may be partitioned into individual data regions.

In response to an application making a request for a predetermined job, the control processor 110 may divide the requested job into a plurality of sub-works, may divide the sub-work into a plurality of tasks, and may appropriately allocate the tasks to the processing cores 121, 122, 123, and 124.

As an example, the control processor 110 may divide the job into four tasks and allocate the tasks to the processing cores 121, 122, 123, and 124, respectively. The processing cores 121, 122, 123, and 124 may independently execute four tasks. In this example, when a single job is divided into a plurality of tasks and each task is processed in a parallel manner, such parallel implementation may be referred to as task level parallel processing or task parallelism.

As another example, a single task, e.g., an image processing task, will be described. When a region of the image processing task is divided into sub-regions such that the region is processed by two or more processors, the control processor 110 may allocate one of the sub-regions to the first processing core 121 and another sub-region to the second processing core 122. In general, in order for the processing time to be equally set, the sub-regions may be provided into a fine grain of sub-regions and may be alternately processed. As described above, when a single task is divided into a plurality of independent data regions and the data regions are processed in a parallel manner, such parallel implementation may be referred to as data level parallel processing or data parallelism.

In order to achieve a parallel processing in consideration of a degree of parallelism (DOP), the control processor 110 may dynamically select one of task level parallel processing and data level parallel processing during an execution of the job. For example, task queues may be not provided in the processing cores 121, 122, 123, and 123, respectively, but tasks may be scheduled in a task queue that is managed by the control processor 110.

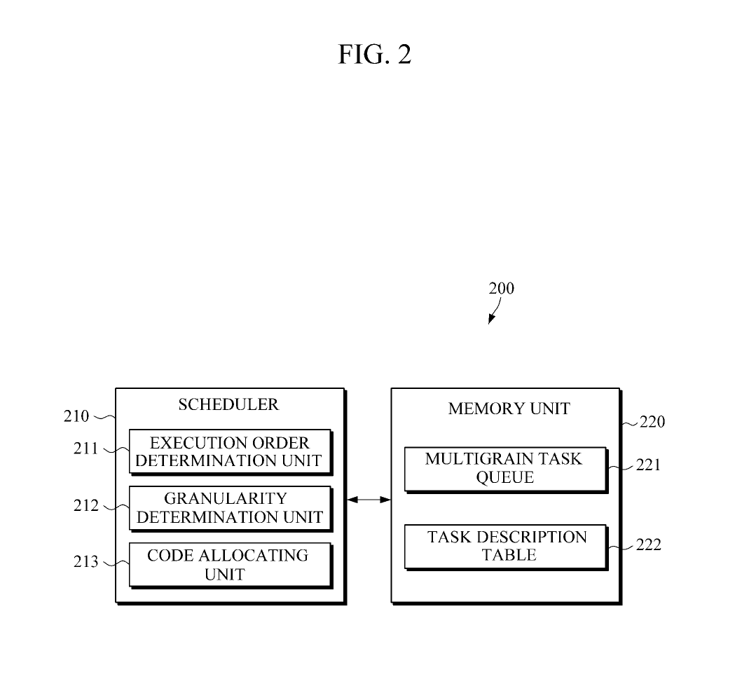

FIG. 2 shows a configuration of an example of a control processor.

As shown in FIG. 2, a control processor 200 may include a scheduling unit 210 and a memory unit 220.

A job requested by a predetermined application may be loaded in the memory unit 220. The scheduling unit 210 may schedule the job loaded in the memory unit 220 into a task level or a data level, and may allocate a sequential version code or a parallel version code to the processing cores 121, 122, 123, and 124. The detailed description of the sequential version code and the parallel version code will be made later.

The memory unit 220 may include a multi grain task queue 221 and a task description table 222.

The multi grain task queue 221 may be a task queue managed by the control processor 110 and may store tasks related to the requested job. The multi grain task queue 221 may store a pointer about a sequential version code and/or a parallel version code.

The sequential version code is a code that is written for a single thread and is optimized such that a single task is processed by a single processing core, e.g., the processing core 121, in a sequential manner. The parallel version code is a code that is written for a multi-thread and is optimized such that a task is processed by a plurality of processing cores, e.g., the processing cores 122 and 123, in a parallel manner. These codes may be differently implemented using two types of binary code that are generated and provided during programming.

The task description table 222 may store task information such as an identifier of each task, an available code for each task, and dependency information between tasks.

The scheduler 210 may include an execution order determination unit 211, a granularity determination unit 212, and a code allocating unit 213.

The execution order determination unit 211 may determine an execution order of tasks stored in the multi grain task queue 221 in consideration of dependency between tasks with reference to the task description table 222.

The granularity determination unit 212 may determine the granularity of task. The granularity may correspond to a task level or a data level. For example, in response to the granularity corresponding to a task level, then task level parallel processing may be performed; and in response to the granularity corresponding to a data level, then data level parallel processing may be performed.

The granularity determination unit 212 may set the granularity to a task level or a data level depending on applications. As an example, the granularity determination unit 212 may give a priority to a task level and may determine the granularity as a task level for a period of time, and in response to an idle processing core existing, the granularity determination unit 212 may determine the granularity as a data level. As another example, based on a profile related to prediction values about execution time of tasks, the granularity determination unit 212 may determine, as a data level, the granularity of a task predicted to have a long execution time.

Based on the determined granularity, the code allocating unit 213 may map tasks to the processing cores 121, 122, 123, and 124 in a one-to-one correspondence, performing task level parallel processing. Alternatively, the code allocating unit 213 may divide a single task into data regions and map the data region to a plurality of processing cores, e.g., the processing cores 122 and 123, performing data level parallel processing.

In response to the code allocating unit 213 allocating tasks to the processing cores 121, 122, 123 and 124, the code allocating unit 213 may select a sequential version code for a task determined as having task level granularity and may allocate the selected sequential version code. In addition, the code allocating unit 213 may select a parallel version code for a task determined as having data level granularity and may allocate the selected parallel version code.

Accordingly, in an example in which a predetermined job is capable of being divided into a plurality of tasks independent of each other, task level parallel processing may be performed to enhance operation efficiency. In addition, in an example in which a load imbalance due to the task level parallel processing is predicated, data level parallel processing may be performed to prevent degradation of performance due to the load imbalance.

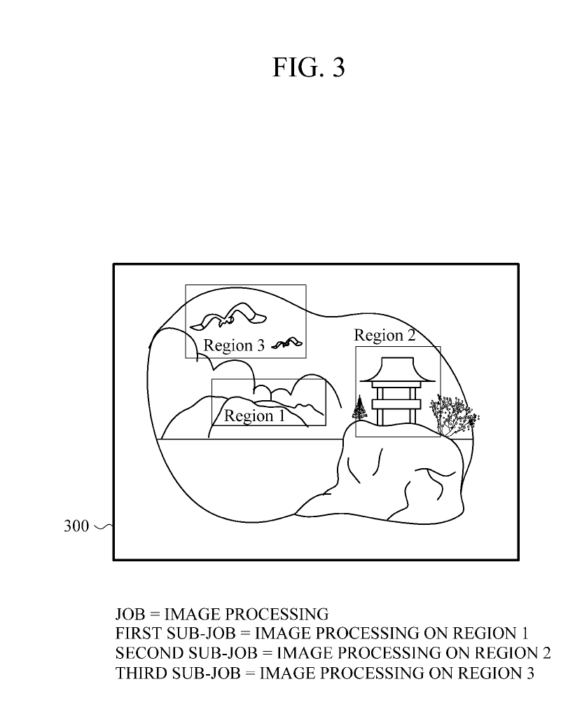

FIG. 3 shows an example of a job 300.

As shown in FIG. 3, an example of a job may represent an image processing job allowing a text to be recognized on an image or job 300.

The job 300 is divided into several sub-jobs. For example, a first sub-job is for processing Region 1, a second sub-job is for processing Region 2, and a third sub-job is for processing Region 3.

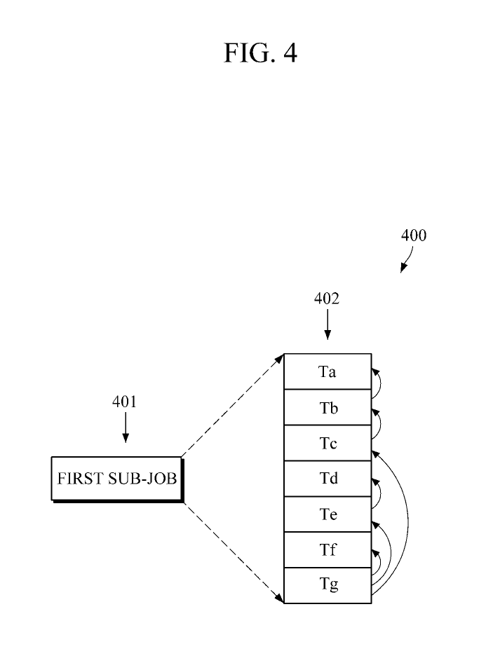

FIG. 4 shows an example of a task 400.

As shown in FIG. 4, the first sub-job 401 may be divided into a plurality of tasks 402. For example, a first sub-job 401 may be a job to process Region 1 shown in FIG. 3.

The first sub-job 401 may include seven tasks Ta, Tb, Tc, Td, Te, Tf, and Tg. The tasks may or may not have a dependency relationship with each other. The dependency relationship between tasks represents an execution order among tasks. For example, Tc may be executed only after Tb is completed. That is, Tc depends on Tb. In addition, when Ta, Td, and Tf are executed independently of each other, individual execution results of Ta, Tb, and Tc may not affect each other. That is, Ta, Td, and Tf have no dependency on each other.

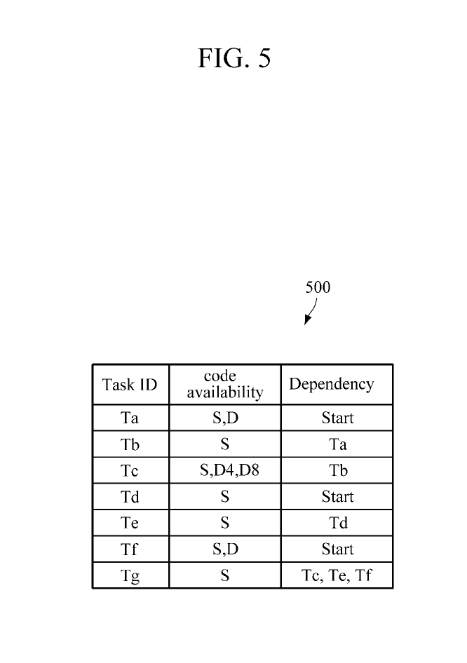

FIG. 5 shows an example of a task description table.

As shown in FIG. 5, the task description table 500 may include a task identifier (Task ID), a code availability, and a dependency between tasks.

The code availability represents information indicating the availability of a sequential version code and a parallel version code for tasks. For example, “S, D” represents that a sequential version code and a parallel version code are available. “S, D4, D8” represents that a sequential version code and a parallel version code are available, and, in addition, an optimum parallel version code is provided when the number of processors is between 2 and 4 and between 5 and 8.

The dependency represents the dependency relationship between tasks. For example, since Ta, Td, and Tf have no dependency relationship, Ta, Td, and Tf may be executed independent of each other. However, Tg is a task which may be executed only after the execution of Tc, Te, and Tf are committed.

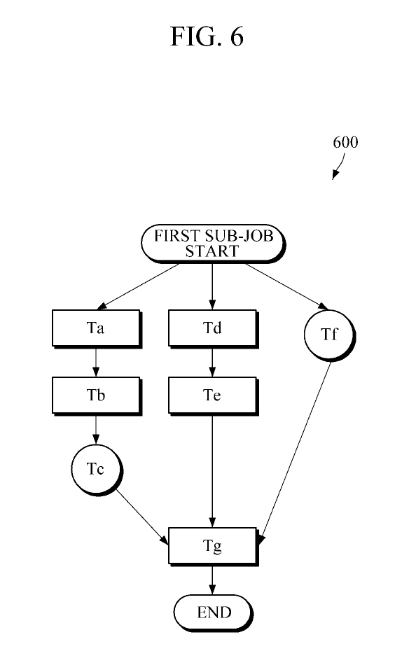

FIG. 6 shows an example of an execution sequence of tasks.

As illustrated in FIG. 6, the sequence 600 shows that the execution order determination unit 211 may determine to first execute Ta, Td, and Tf that have no dependency on each other with reference to the task description table 500.

The granularity determination unit 211 may determine the granularity of Ta, Td, and Tf determined to be first executed. The code allocating unit 213 may select one of the sequential version code and the parallel version code based on the determined granularity and may allocate the selected code.

As one example, in response to the granularity being determined to be at a task level, the code allocating unit 213 may select a sequential version code for Ta with reference to the task description table 500, and may allocate the selected sequential version code to one of the processing cores 121, 122, 123, and 124.

As another example, in response to the granularity being determined to be at a data level, the code allocating unit 213 may select a parallel version code for Ta with reference to the task description table 500, and may allocate the selected parallel version code to at least two of the processing cores 121, 122, 123, and 124.

In the above example, when mapping Ta, Td, and Tf to the processing cores, a sequential version code may be selected for each of Ta and Td and sequential version codes may be mapped to the processing cores in a one-to-one correspondence. In addition, a parallel version code may be selected for Tf and the selected parallel version code may be mapped to the processing cores, e.g., processing cores 121, 122, 123, and 124.

That is, a sequential version code of Ta may be allocated to the first processing core 121, a sequential version code of Td may be allocated to the second processing core 122, and a parallel version code of Tf may be allocated to the third processing core 123 and an n^{th} processing core 124, achieving a parallel processing.

In this regard, when performing a parallel processing on a predetermined algorithm for both of a task level and a data level, a load imbalance may be minimized and the maximum degree of parallelism (DOP) and an optimum execution time may be achieved.

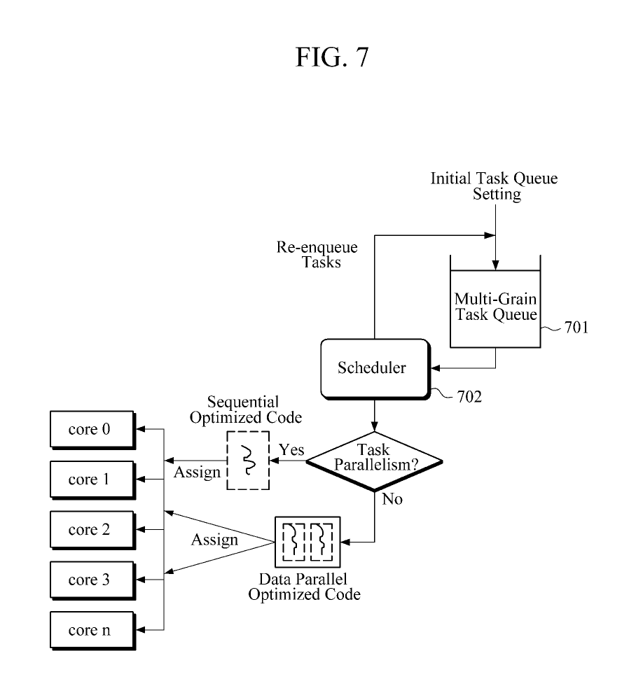

FIG. 7 shows an example of operations of the parallel processing apparatus.

As shown in FIG. 7, scheduling for parallel processing may be performed in a multi grain task queue 701. For example, in response to a task stored in the multi grain task queue 701 being determined to be at a task level, a sequential version code may be mapped to one of available processing cores, performing the task-level parallel processing. In response to a task being determined to be at a data level, a parallel version code may be mapped to available processing cores, performing the data-level parallel processing.

In addition, the scheduler 702 may schedule tasks based on any dependency between the tasks. The information about dependency may be obtained from the task description table 500 shown in FIG. 5.

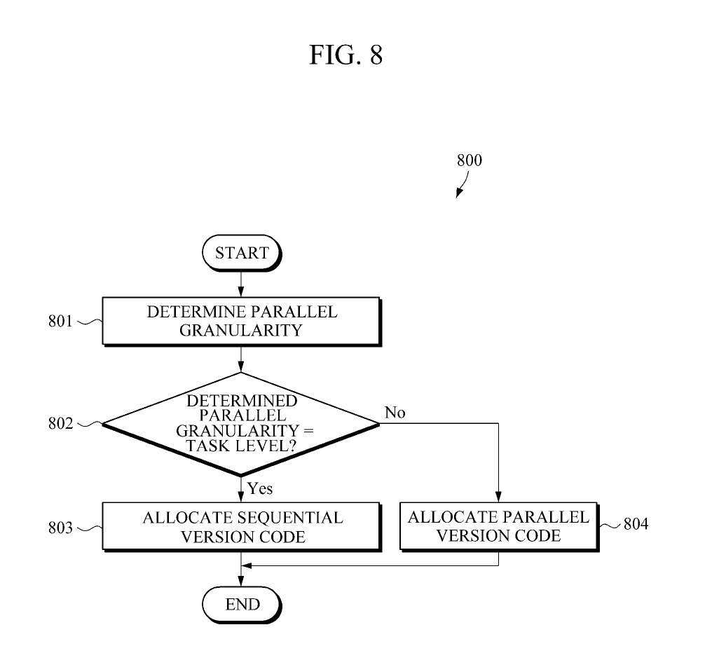

FIG. 8 shows an example of a method of parallel processing.

The example of the parallel processing method 800 may be applied to a multi core system or a multi processing system. In particular, the example of the parallel processing method may be applied when multi-sized images are generated from a single image and as such a fixed parallel processing is not efficient.

As shown in FIG. 8, in operation 801, in response to a request for a predetermined job processing being made by an application, the granularity on the request job may be determined. The granularity may be at a task level or a data level. The criteria of determination may be variously set. For example, a task level may be first selected until an idle processor appears and then a data level may be selected.

In operation 802, it may be determined whether the granularity corresponds to a task level or a data level. In operation 803, at the result of determination, in response to the granularity being at a task level, a sequential version code may be allocated. In operation 804, in response to the granularity being at a data level, a parallel version code may be allocated.

In the allocating of sequential version code, a plurality of tasks may be mapped to a plurality of processing cores in a one-to-one correspondence for a task level parallel processing. In the allocating of parallel version code, a single task may be mapped to a plurality of processing cores for a data level parallel processing.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD-ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

As a non-exhaustive illustration only, the computing system or a computer described herein may refer to mobile devices such as a cellular phone, a personal digital assistant (PDA), a digital camera, a portable game console, and an MP3 player, a portable/personal multimedia player (PMP), a handheld e-book, a portable laptop and/or tablet PC, a global positioning system (GPS) navigation, and devices such as a desktop PC, a high definition television (HDTV), an optical disc player, a setup box, and the like.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of example embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for parallel processing, the apparatus comprising:
at least one processing core configured to process a job;
a granularity determination unit configured to determine a parallelism granularity of the job; and
a code allocating unit configured to:
select one of a sequential version code and a parallel version code, based on the determined parallelism granularity; and
allocate the selected code to the processing core.

2. The apparatus of claim 1, wherein the granularity determination unit is further configured to determine whether the parallelism granularity is at a task level or a data level.

3. The apparatus of claim 2, wherein the code allocating unit is further configured to:
in response to the determined parallelism granularity being at the task level, allocate a sequential version code of a task related to the job to the processing core; and
in response to the determined parallelism granularity being at the data level, allocate a parallel version code of a task related to the job to the processing core.

4. The apparatus of claim 3, wherein the code allocating unit is further configured to:
in the allocating of the sequential version code of the task to the processing core, map a sequential version code of a single task to one of the processing cores in a one-to-one correspondence; and
in the allocating of the parallel version code of the task to the processing core, map a parallel version code of a single task to different processing cores.

5. The apparatus of claim 1, further comprising a memory unit configured to contain a multigrain task queue, configured to store at least one of: a plurality of tasks related to the job, a sequential version code of each task, a parallel version code of each task, and a predetermined task description table.

6. The apparatus of claim 5, wherein the task description table is further configured to store at least one of: identification information of each task, dependency information between the tasks, and code information available for each task.

7. The apparatus of claim 5, wherein the granularity determination unit is further configured to dynamically determine the parallelism granularity with reference to the memory unit.

8. A method of parallel processing, the method comprising:
determining a parallelism granularity of a job;
selecting one of a sequential version code and a parallel version code based on the determined parallelism granularity; and
allocating the selected code to at least one processing core for processing the job.

9. The method of claim 8, wherein the determining of the parallelism granularity comprises determining whether the parallelism granularity is at a task level or a data level.

10. The method of claim 9, wherein the allocating of the selected code comprises:
in response to the determined parallelism granularity being at the task level, allocating a sequential version code of a task related to the job to the processing core; and
in response to the determined parallelism granularity being at the data level, allocating a parallel version code of a task related to the job to the processing core.

11. The method of claim 10, wherein the allocating of the selected code comprises:
mapping a sequential version code of a single task to one of the processing cores in a one-to-one correspondence, in the allocating of the sequential version code of the task to the processing core; and
mapping a parallel version code of a single task to different processing cores, in the allocating of the parallel version code of the task to the processing core.

12. The method of claim 8, further comprising storing, in a memory unit, at least one of: a plurality of tasks related to the job, a sequential version code of each task, a parallel version code of each task, and a predetermined task description table.

13. The method of claim 12, wherein the task description table stores at least one of: identification information of each task, dependency information between the tasks, and code information available for each task.

14. The method of claim 12, further comprising dynamically determining the parallelism granularity with reference to the memory unit.

15. An apparatus for parallel processing, the apparatus comprising:
a code allocating unit configured to:
select one of a sequential version code and a parallel version code, based on a parallelism granularity; and
allocate the selected code.
